(19) United States
(12) Patent Application Publication
(10) Pub. No.: US 2026/0112905 A1
(43) Pub. Date: Apr. 23, 2026

(54) BATTERY SYSTEM SELECTIVELY CONFIGURABLE FOR HIGH VOLTAGE CHARGING

(71) Applicant: Our Next Energy, Inc., Novi, MI (US)

(72) Inventors: Krzysztof Klesyk, Novi, MI (US); Yingying Gui, Novi, MI (US); Yan Zhou, Canton, MI (US); Richard Hampo, Ann Arbor, MI (US)

(73) Assignee: Our Next Energy, Inc., Novi, MI (US)

(21) Appl. No.: 19/365,476

(22) Filed: Oct. 22, 2025

Related U.S. Application Data
(60) Provisional application No. 63/710,816, filed on Oct. 23, 2024.

(51) Int. Cl. H02J 7/00

(52) U.S. Cl. CPC H02J 7/65; H02J 7/575; H02J 7/685; H02J 7/80

(57) ABSTRACT

A battery system for allowing discharge of batteries in parallel and charging in series, while eliminating or reducing the risks and damage associated with short circuits, includes first and second batteries, parallel contactors electrically connecting the batteries in parallel to a high voltage bus when they are closed, a mid-contactor electrically connecting the batteries in series when the mid-contactor is closed, and a logic circuit for preventing closure of the mid-contactor when any of the parallel contactors is closed.

### CROSS-REFERENCE TO RELATED APPLICATION

This application claims priority to U.S. Provisional Application No. 63/710,816, filed October 23, 2024, which is incorporated herein by reference in its entirety.

### FIELD OF THE DISCLOSURE

This disclosure relates generally to battery systems and more particularly to battery systems including switches for selectively arranging two or more batteries in parallel when normal loads are applied and in series during charging.

### BACKGROUND OF THE DISCLOSURE

Faster charging of high voltage batteries can be achieved when batteries normally connected in parallel during discharge are rearranged in series during charging. This can be facilitated by providing contactors that are opened to disconnect parallel connections between the batteries and the high voltage positive and negative buses and providing other contactors that can be closed to connect the batteries in series with the high voltage buses.

A problem with such arrangements is that a short circuit can develop if a series connection between the batteries is made while the parallel contactors are still closed. Such short circuiting can cause damage to the batteries and could lead to generation of excessive heat and gas capable of causing excessive risk of danger and damage from fires and explosions.

### SUMMARY OF THE DISCLOSURE

In certain embodiments, a battery system that can safely be selectively reconfigured for fast charging includes a first battery, a first positive contactor that electrically connects a positive terminal on the first battery with a positive voltage bus when the first positive contactor is closed and a first negative contactor that electrically connects a negative terminal on the first battery with a negative voltage bus when the first negative contactor is closed; a second battery; a second positive contactor that electrically connects a positive terminal on the second battery with the positive voltage bus when the second positive contactor is closed and a second negative contactor that electrically connects a negative terminal on the second battery with the negative voltage bus when the second negative contactor is closed; a mid-contactor that electrically connects the first negative terminal with the second positive terminal when the mid-contactor is closed; and an interlock circuit that prevents closure of the mid-contactor when a status of any one of the first positive contactor, the first negative contactor, the second positive contactor or the second negative contactor is closed.

In some embodiments, the battery system can be provided with a first fast-charge contactor that electrically connects the first positive terminal with a positive charging terminal when the first fast-charge contactor is closed; and/or a second fast-charge contactor that electrically connects the second negative battery terminal with a negative charging terminal when the second fast-charge contactor is closed.

The disclosed battery systems can be characterized as having first and second batteries, parallel contactors for electrically connecting the batteries to a positive bus and a negative bus in parallel, a mid-contactor for electrically connecting the batteries in series to terminals (positive and negative) of a fast-charger, and an interlock circuit that prevents closure of the mid-contactor when any of the parallel contactors is closed.

Any of various logic circuits having AND-gates and/or OR-gates can be used to generate a control signal to allow closure of the mid-contactor only when all of the parallel contactors are open using contactor status signals.

The contactor status signals can be detected using sensors, such as a voltage meter an ohmmeter or an ammeter.

In some embodiments, the interlock circuit can have a sub-circuit including an OR-gate that receives a first input indicative of the status of a contactor and a second input indicative of the command status of the contactor (i.e., the state ordered by a system controller), and an AND-gate that receives an output from the OR-gate and a signal to close the mid-contactor. An output from the AND-gate can authorize closure of the mid-contactor when the actual status and command status agree that the contactor is open and a command to close the mid-contactor is provided. One such sub-circuit can be provided for each of the first positive contactor, the first negative contactor, the second positive contactor, and the second negative contactor. The outputs from each of the sub-circuits can be input to an AND-gate to allow closure of the mid-contactor when closure of the mid-contactor is commanded, and each of the first positive contactor, the first negative contactor, the second positive contactor, and the second negative contactor has been commanded to be open and is actually open.

### BRIEF DESCRIPTION OF THE DRAWINGS

FIG. 1 is a schematic diagram illustrating a battery system in accordance with this disclosure showing parallel contactors closed and the mid-contactor open to allow discharge of the batteries to loads applied to a high voltage bus.

FIG. 2 is a schematic diagram illustrating the battery system of FIG. 1 with the parallel contactors open and the mid-contactor closed for fast charging.

FIG. 3 is a schematic diagram showing a battery system similar to the disclosed system, but lacking an interlock circuit to prevent short circuiting as illustrated.

FIG. 4 is an exemplary interlock circuit for preventing closure of the mid-contactor when any one or more of the parallel contactors is closed.

FIG. 5 is a simplified logic circuit for preventing closure of the mid-contactor when a parallel contactor actual (i.e., detected) status and command status (as ordered by a system controller) are not both open (open-status).

### DETAILED DESCRIPTION

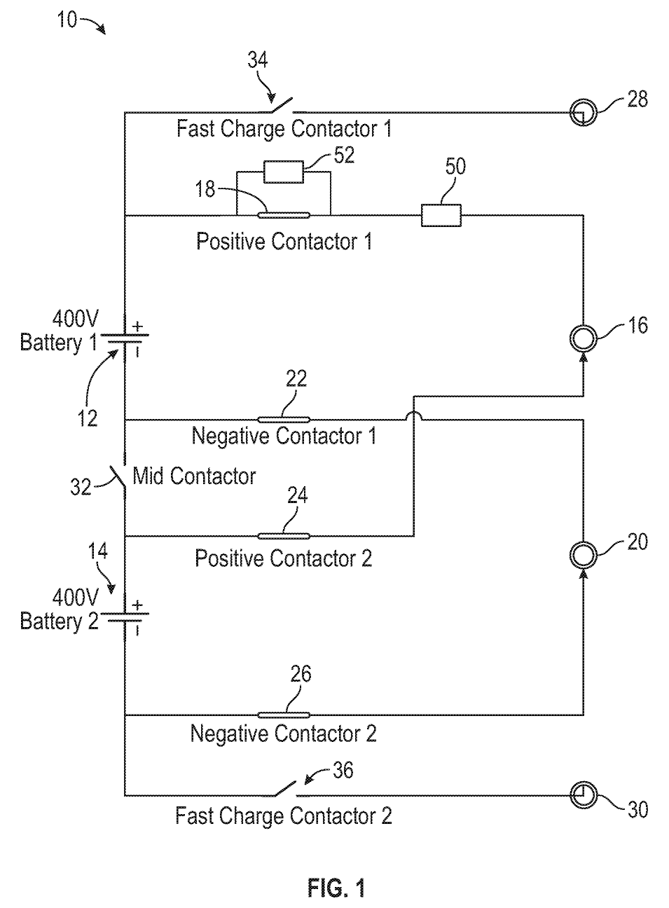

An exemplary battery system 10 in accordance with this disclosure is shown in FIG. 1. The system includes a first battery 12 and a second battery 14. The positive terminal of battery 12 is electrically connected to a positive bus terminal 16 when a first positive contactor 18 is closed (as illustrated in FIG. 1). The negative terminal of battery 12 is electrically connected to a negative bus terminal 20 when first negative contactor 22 is closed (as illustrated in FIG. 1). The positive terminal of battery 14 is electrically connected to the positive bus terminal 16 when a second positive contactor 24 is closed (as illustrated in FIG. 1). The negative terminal of battery 14 is electrically connected to the negative bus terminal 20 when a second negative contactor 26 is closed (as illustrated in FIG. 1). A positive fast charge contactor 34 (open in FIG. 1) is provided to electrically connect the positive terminal of battery 12 with a fast charger positive terminal 28, and a negative fast charge contactor 36 (open in FIG. 1) is provided to electrically connect the negative terminal of battery 14 with a fast charger negative terminal 30. A mid-contactor 32 (open in FIG. 1) allows batteries 12 and 14 to serially connected during fast charging. The status of each contactor (open or closed) as shown in FIG. 1 allows batteries 12 and 14 to concurrently discharge at a lower voltage (e.g., 400V) to loads (e.g., HVAC, motors, etc.) connected with the high voltage buses.

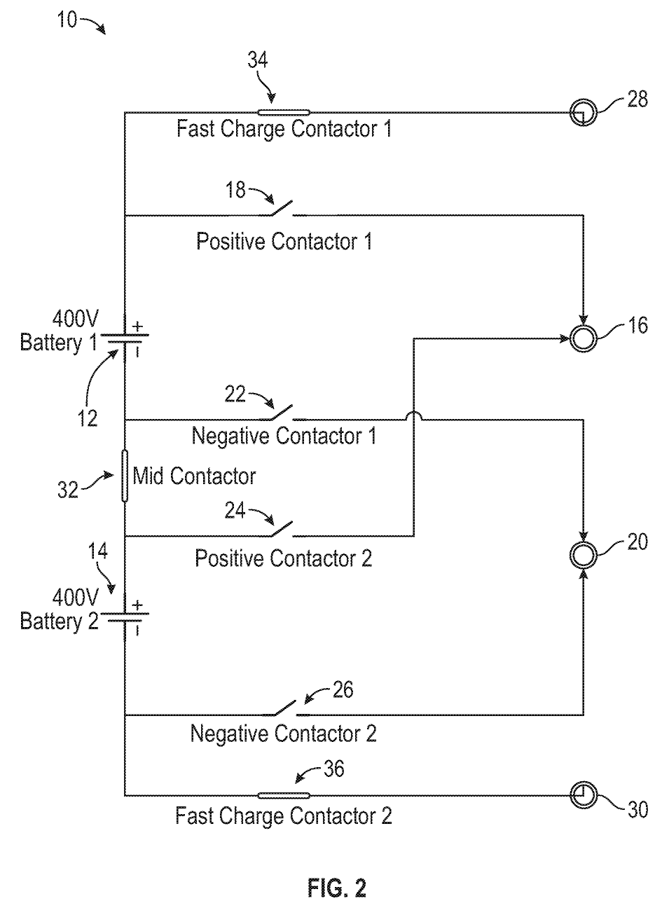

FIG. 2 shows the battery system 10 with the various contactors configured to prevent discharge or electrical connection with the high voltage bus terminals 16, 20, and allow batteries 12 and 14 to be connected in series for fast charging.

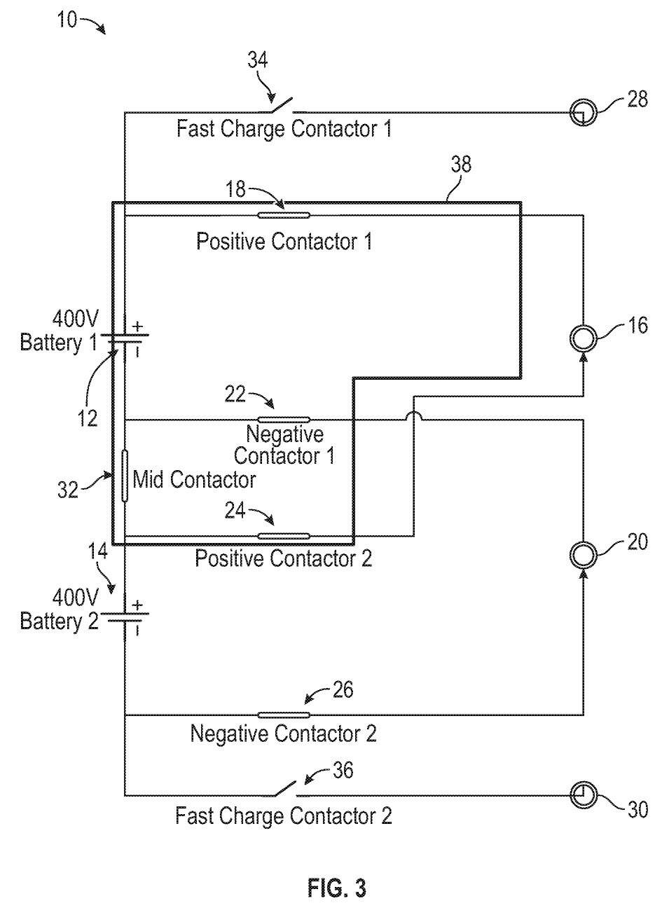

FIG. 3 shows an undesirable and potentially dangerous condition (not representative of the disclosed systems) in which the parallel contactors and the mid-contactors are simultaneously closed short circuiting the positive and negative terminals of each battery. The short circuit for battery 12 is schematically represented by the illustrated loop 38. The condition shown in FIG. 3 should be avoided even for a short period of time to avoid damage and possible fire and/or explosion risks.

Such damage and risks are avoided with the disclosed system having an interlock circuit that prevents closure of mid-contactor unless contactors 18, 22, 24 and 26 are open (as illustrated in FIG. 2).

Logic circuits for receiving status signals (open or closed) for each of contactors 18, 22, 24 and 26 and a control signal (e.g., from a system controller, not shown) commanding closing of the mid-contactor for fast charging) and processing such signals to allow the command to be executed only if contactors 18, 22, 24 and 26 are open.

The interlock circuit may be achieved using discrete gates, field programmable gate arrays (FPGAs) or other programmable interpreted circuits.

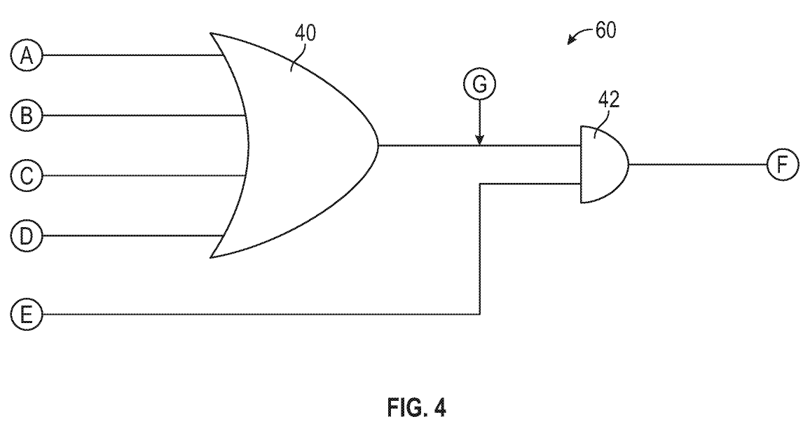

An exemplary interlock circuit 60 (shown in FIG. 4) includes an OR-gate 40 receiving a signal (A, B, C and D) from each of the first positive contactor, the first negative contactor, second positive contactor, and the second negative contactor that is indicative of the status of the contactor (e.g., “0” for contactor closed, “l” for contactor open), and an AND-gate 42 receiving an output signal from the OR-gate and an interlock signal E (“1” to close the mid-contactor, “0” to open the mid-contactor). The output G from OR-gate 40 can only be “1” when all inputs A, B, C and D are “1” (contactors open). An output control signal F to close the mid-contactor (with a value of “1”) requires that inputs A, B, C, D and E are all “1” (i.e., first positive contactor, first negative contactor, second positive contactor, and second negative contactor are all open), and a signal to close the mid-contactor has been generated.

Status signals indicating whether the parallel contactors 18, 22, 24 and 26 are open or closed can be developed using 50 sensors, such as a voltage (electrical potential) meter or auxiliary contactor 52. The sensor output can be an analog or digital output than can be provided to a system controller that determines contactor status (opened or closed) and transmit a status signal for each parallel contactor to the interlock circuit.

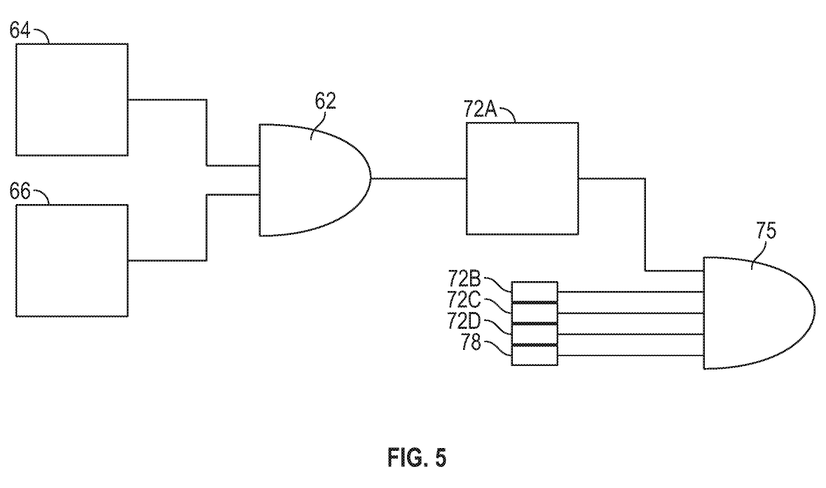

In certain embodiments, interlock circuit 60 can be configured to allow mid-contactor 32 to close only if the actual (detected) status of each parallel contactor is open and the command to each of the parallel contactors is also open. A simplified logic circuit for achieving this for each parallel contactor is shown in FIG. 5. An AND-gate 62 is provided to receive an actual status signal 64 from a parallel contactor and a command status signal 66. An output 72A from AND-gate 62 can be input to another AND-gate 75 that receives corresponding signals 72B, 72C and 72D from similar logic circuitry for each parallel contactor. AND-gate 75 can also receive a command signal 78 requesting closure of the mid-contactor 32. In such arrangement, the command is only executed if the command signal to each parallel contactor is “open” and the detected (actual) condition or status of each parallel contactor is also “open”.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. A battery system comprising:
a first battery;
a first positive contactor that electrically connects a positive terminal on the first battery with a positive voltage bus when the first positive contactor is closed and a first negative contactor that electrically connects a negative terminal on the first battery with a negative voltage bus when the first negative contactor is closed;
a second battery;
a second positive contactor that electrically connects a positive terminal on the second battery with the positive voltage bus when the second positive contactor is closed and a second negative contactor that electrically connects a negative terminal on the second battery with the negative voltage bus when the second negative contactor is closed;
a mid-contactor that electrically connects the first negative terminal with the second positive terminal when the mid-contactor is closed; and
an interlock circuit that prevents closure of the mid-contactor when a status of any one of the first positive contactor, the first negative contactor, the second positive contactor, or the second negative contactor is closed.

2. The battery system of claim 1, further comprising:
a first fast-charge contactor that electrically connects the first positive terminal with a positive charging terminal when the first fast-charge contactor is closed; and
a second fast-charge contactor that electrically connects the second negative battery terminal with a negative charging terminal when the second fast-charge contactor is closed.

3. The battery system of claim 1, wherein the interlock circuit includes a first AND-gate receiving a signal indicative of the status of each of the first positive contactor, the first negative contactor, the second positive contactor, and the second negative contactor, and a second AND-gate that receives the output from the first AND-gate and a signal to close the mid-contactor, and wherein an output from the second AND-gate closes the mid-contactor when the first positive contactor, the first negative contactor, the second positive contactor and the second negative contactor are all open and a signal to close the mid-contactor has been provided to the second AND-gate.

4. The battery system of claim 1, wherein the battery system further comprises a sensor for detecting one or more of electrical resistance through electrical current or electrical potential drop across each of the first positive contactor, the first negative contactor, the second positive contactor, and the second negative contactor.

5. The battery system of claim 4, wherein each of the sensors is one or more of a voltage meter, and an auxiliary contactor.

6. The battery system of claim 1, wherein the interlock circuit prevents closure of the mid-contactor when a command status of any one of the first positive contactor, the first negative contactor, the second positive contactor and the second negative contactor is closed.

7. The battery system of claim 1, wherein the interlock circuit is configured to allow closure of the mid-contactor only when an actual detected status and the command status of the first positive contactor, the first negative contactor, the second positive contactor and the second negative contactor are open.

8. A battery system comprising:
a first battery;
a second battery;
parallel contactors electrically connecting the first battery and the second battery to a positive bus and a negative bus in parallel when the parallel contactors are closed;
a mid-contactor electrically connecting the batteries in series when the mid-contactor is closed; and
an interlock circuit preventing closure of the mid-contactor when any of the parallel contactors are closed.

9. The battery system of claim 8, wherein the battery system further comprises a sensor for detecting one or more of electrical resistance through electrical current or electrical potential drop across each of the first positive contactor, the first negative contactor, the second positive contactor, and the second negative contactor.

10. The battery system of claim 9, wherein each of the sensors is one or more of a voltage meter, and an auxiliary contactor.

11. The battery system of claim 8, wherein the interlock circuit prevents closure of the mid-contactor when a command status of any one of the first positive contactor, the first negative contactor, the second positive contactor and the second negative contactor is closed.

12. The battery system of claim 8, wherein the interlock circuit is configured to allow closure of the mid-contactor only when an actual detected status and the command status of the first positive contactor, the first negative contactor, the second positive contactor and the second negative contactor are open.
